(19) United States
(12) Patent Application Publication
(10) Pub. No.: US 2003/0139182 A1
(43) Pub. Date: Jul. 24, 2003

(54) Solution for restricting roaming in mobile telephony systems

(75) Inventors: Line Bakkeby, Fevik (NO); Ingrid Christensen, Kolbjornsvik (NO); Frode Bjelland, Arendal (NO); Einar Oltedal, Kolbjornsvik (NO)

Correspondence Address: ERICSSON INC., 6300 LEGACY DRIVE, M/S EVW2-C-2, PLANO, TX, 75024, US

(73) Assignee: Telefonaktiebolaget LM Ericsson (publ), Stockholm (SE)

(21) Appl. No.: 10/346,930

(22) Filed: Jan. 17, 2003

(30) Foreign Application Priority Data
Jan. 18, 2002 (NO) 2002.0290

(51) Int. Cl. H04Q 7/20

(52) U.S. Cl. 455/432; 455/351

(57) ABSTRACT

The present invention discloses a method for executing roaming restrictions in GPRS and UMTS networks. A preferred embodiment of the present invention purposes that the SGSNs of the network stores the IMSI numbers or IMSI series having roaming restrictions in parts or whole of the respective areas covered by the SGSNs. The SGSNs may then easily check if an MS is allowed to roam into an area when receiving the MS data in an initiated roaming procedure, and then be able to terminate the procedure in time before the old SGSN is made unable to keep handling the MS. Other embodiments of the present invention propose to provide the roaming restrictions for the respective MSs from the subscription data in the HLRs early in the roaming procedure so that it may be terminated in time. By means of the present invention, unnecessary disconnections of MSs from the network in connection with roaming are avoided This is expected to be a growing problem in GPRS and UMTS networks implemented according to the current standard.

### FIELD OF THE INVENTION

The present invention is related to roaming restrictions in GPRS and UMTS networks, in particular to handling MSs (Mobile Station) roaming from a first area covered by one SGSN into a second area covered by another.

### BACKGROUND OF THE INVENTION

Roaming between cellular network operators has been possible ever since mobile communication became commercially available. Roaming means that a subscriber with a subscription at a first operator may be connected to and employ a network of a second operator in the same way as for the second operator's own subscribers. An agreement between the operators and certain technical implementations between their respective networks must exist to make roaming them between possible.

Traditionally, roaming agreements have been entered only between operators of different countries. The reason of this is that the different operators want to offer the best coverage possible, also outside their own networks, without giving their national competitors access to their own network.

To save cost, operators have now started to co-operate more and more. There is several ways operators might co-operate. One way to achieve this is that two or more operators share some parts of the network. In GPRS and UMTS, this can e.g. be achieved by the operators sharing the whole RAN (Radio Access Network) in one or more geographical area, but have separate SGSNs. Another way of sharing a network is that they only share one or more RNCs (Radio Network Controller), but have separate radio cells as well as SGSNs.

Another area of co-operation that now seems to become popular is that some operators do not intend to deploy a network that covers a whole country. Instead, they come to an agreement with another operator for some areas of the country. The subscribers of the first operator are then allowed to use the network of the other operator in the areas where the first operator has no coverage. However, when the subscriber moves from an area covered by the second operator (and not the first operator) into an area covered by the first operator, the MS should again become attached to an SGSN of the first operator, even though an SGSN of the second operator could have served the MS in this area. Moreover, the MS should not lose its existing PDP (Packet Data Protocol) contexts when becoming attached to this other SGSN, as this would be perceived as GPRS being a poor service.

Naturally, an operator must also be able to deny subscribers from some operators to get access to some or all of its SGSN, or to one or more areas served by one SGSN.

Other reasons for the operators to be able to restrict MSs from roaming into an area and getting access to an SGSN other than those discussed above, may also be considered.

In a 3GPP (3rd Generation Partnership Project) meeting the of Dec. 14, 2001, a solution was accepted for how the MS could move into a new area, and keep its MS data and the associated PDP contexts even though the MS was not allowed to roam into this area, or it was not allowed to get access to a certain SGSN. However, there is a problem with the accepted solution. The problem is that it will only work when the MS moves between two areas being served by the same SGSN, and not when the MS moves between two areas being served by different SGSNs.

For a better understanding of the problem, the RAU (Routing Area Update) procedure for GSM (Global System for Mobile Communication) GPRS will now be explained referring to FIG. 1, according to 3GPP TS (Technical Specification) 23.060.

1) The MS sends a Routing Area Update Request (old RAI, old P-TMSI Signature, Update Type, Classmark, DRX parameters and MS Network Capability) to the new SGSN. Update Type shall indicate RA update or periodic RA update. The BSS shall add the Cell Global Identity including the RAC and LAC of the cell where the message was received before passing the message to the SGSN. Classmark contains the MS GPRS multislot capabilities and supported GPRS ciphering algorithms is as defined in TS 24.008. DRX Parameters indicates whether or not the MS uses discontinuous reception and the DRX cycle length.

2) The new SGSN sends SGSN Context Request (old RAI, TLLI, old P-TMSI Signature, New SGSN Address) to the old SGSN to get the MM and PDP contexts for the MS. The old SGSN validates the old P-TMSI Signature and responds with an appropriate error cause if it does not match the value stored in the old SGSN. This should initiate the security functions in the new SGSN. If the security functions authenticate the MS correctly, the new SGSN shall send an SGSN Context Request (old RAI, TLLI, MS Validated, New SGSN Address) message to the old SGSN. MS Validated indicates that the new SGSN has authenticated the MS. If the old P-TMSI Signature was valid or if the new SGSN indicates that it has authenticated the MS, the old SGSN stops assigning SNDCP N-PDU numbers to downlink N-PDUs received, and responds with SGSN Context Response (MM Context, PDP Contexts). If the MS is unknown to the old SGSN, the old SGSN responds with an appropriate error cause. The old SGSN stores New SGSN Address to allow the old SGSN to forward data packets to the new SGSN. Each PDP Context includes the SNDCP Send N-PDU Number for the next downlink N-PDU to be sent in acknowledged mode to the MS, the SNDCP Receive N-PDU Number for the next uplink N-PDU to be received in acknowledged mode from the MS, the GTP sequence number for the next downlink N-PDU to be sent to the MS and the GTP sequence number for the next uplink N-PDU to be tunnelled to the GGSN. The old SGSN starts a timer and stops the transmission of N-PDUs to the MS. The new SGSN shall ignore the MS Network Capability contained in MM Context of SGSN Context Response only when it has previously received an MS Network Capability in the Routeing Area Request.

3) Security functions may be executed. These procedures are defined in clause “Security Function”. Ciphering mode shall be set if ciphering is supported.

If the security functions fail (e.g. because the SGSN cannot determine the HLR address to establish the Send Authentication Info dialogue), the Inter SGSN RAU Update procedure fails. A reject shall be returned to the MS with an appropriate cause.

4) The new SGSN sends an SGSN Context Acknowledge message to the old SGSN. This informs the old SGSN that the new SGSN is ready to receive data packets belonging to the activated PDP contexts. The old SGSN marks in its context that the MSC/VLR association and the information in the GGSNs and the HLR are invalid. This triggers the MSC/VLR, the GGSNs, and the HLR to be updated if the MS initiates a routeing area update procedure back to the old SGSN before completing the ongoing routing area update procedure. If the security functions do not authenticate the MS correctly, then the routeing area update shall be rejected, and the new SGSN shall send a reject indication to the old SGSN. The old SGSN shall continue as if the SGSN Context Request was never received.

5) The old SGSN duplicates the buffered N-PDUs and starts tunneling them to the new SGSN. Additional N-PDUs received from the GGSN before the timer described in step 2expires are also duplicated and tunnelled to the new SGSN. N-PDUs that were already sent to the MS in acknowledged mode and that are not yet acknowledged by the MS, are tunnelled together with the SNDCP N-PDU number. No N-PDUs shall be forwarded to the new SGSN after expiry of the timer described in step 2.

6) The new SGSN sends Update PDP Context Request (new SGSN Address, TEID, QoS Negotiated) to the GGSNs concerned. The GGSNs update their PDP context fields and return Update PDP Context Response (TEID).

7) The new SGSN informs the HLR of the change of SGSN by sending Update Location (SGSN Number, SGSN Address, TMSI) to the HLR.

8) The HLR sends Cancel Location (IMSI, Cancellation Type) to the old SGSN with Cancellation Type set to Update Procedure. If the timer described in step 2 is not running, the old SGSN removes the MM and PDP contexts. Otherwise, the contexts are removed only when the timer expires. This allows the old SGSN to complete the forwarding of N-PDUs. It also ensures that the MM and PDP contexts are kept in the old SGSN in case the MS initiates another inter-SGSN routing area update before completing the ongoing routing area update to the new SGSN. The old SGSN acknowledges with Cancel Location Ack (IMSI).

9) The HLR sends Insert Subscriber Data (IMSI, GPRS Subscription Data) to the new SGSN. The new SGSN validates the MS's presence in the (new) RA. If due to regional subscription restrictions the MS cannot attach to the RA, the SGSN rejects the Routeing Area Update Request with an appropriate cause, and may return an Insert Subscriber Data Ack (IMSI, SGSN Area Restricted) message to the HLR. If all checks are successful, the SGSN constructs an MM context for the MS and returns an Insert Subscriber Data Ack (IMSI) message to the HLR.

10) The HLR acknowledges the Update Location by sending Update Location Ack (IMSI) to the new SGSN.

11) The new SGSN validates the MS's presence in the new RA. If due to roaming restrictions the MS is not allowed to be attached in the SGSN, or if subscription checking fails, the new SGSN rejects the routing area update with an appropriate cause. If all checks are successful, the new SGSN constructs MM and PDP contexts for the MS. A logical link is established between the new SGSN and the MS. The new SGSN responds to the MS with Routing Area Update Accept (P-TMSI, P-TMSI Signature, Receive N-PDU Number). Receive N-PDU Number contains the acknowledgements for each acknowledged-mode NSAPI used by the MS, thereby confirming all mobile-originated N-PDUs successfully transferred before the start of the update procedure.

12) The MS acknowledges the new P-TMSI by returning a Routing Area Update Complete (Receive N-PDU Number) message to the SGSN. Receive N-PDU Number contains the acknowledgements for each acknowledged-mode NSAPI used by the MS, thereby confirming all mobile-terminated N-PDUs successfully transferred before the start of the update procedure. If Receive N-PDU Number confirms reception of N-PDUs that were forwarded from the old SGSN, these N-PDUs shall be discarded by the new SGSN. LLC and SNDCP in the MS are reset.

The important points to notice in the description of the standard above are that the new SGSN will receive the MS data from the old SGSN in step 2 (SGSN Context Request/Response), and the old SGSN will start a timer (specified to have a default value of 20 seconds). In step 4 the new SGSN informs the old SGSN that it was able to handle the MS and the associated PDP contexts (SGSN Context Acknowledge), so from now on the new SGSN is responsible for the GTP (GPRS Tunnelling Protocol) tunnels towards the involved GGSN(s) (Gateway GPRS Support Node). In step 6, the new SGSN updates the GTP tunnels towards the involved GGSN(s) (Update PDP Context Request/Response). When the new SGSN informs the HLR (Home Location Register) that the MS has moved to an area covered by a new SGSN in step 7 (Update Location), the HLR will order the old SGSN to delete the MS data in step 8 (Cancel Location). (The MS data will, however, not be deleted from the old SGSN until both the timer mentioned in step 2 has elapsed and the Cancel Location message is received.) Now, everything is settled for the new SGSN to handle the MS.

However, in the current standardised solution for roaming restrictions, the HLR will in step 9 send Insert Subscriber Data to the new SGSN with information of roaming restrictions for the MS. Not until this message is received, the new SGSN will be able to detect that the MS was not allowed to roam into this area, and the new SGSN will send a Routing Area Update Reject message to the MS. As a matter of fact, there is no longer any means for the MS data and the PDP contexts to remain in the old SGSN since the HLR already has ordered it to delete the MS data and since the above-mentioned timer at this time probably has elapsed. Also, the MS data and the PDP contexts cannot remain in the new SGSN since the new SGSN cannot give a new temporary identity, P-TMSI (Packet-Temporary Mobile Subscriber Identity), to the MS in the RAU Reject message.

For the SRNS Relocation procedure in UMTS, there is the problem that the new SGSN will not receive the subscription data of the MS from the HLR. The subscription data is not received until the RAU procedure is performed, and this procedure is initiated by the MS as soon as the SRNS Relocation procedure is finished.

In brief, the problem is that when the new SGSN discovers that the MS is not allowed to roam into a certain area, neither the old SGSN nor the new SGSN can keep the MS data. The MS will then be disconnected from the network. Because of the increasing co-operation between operators mentioned above, this is likely to occur relatively often, and therefore the subscribers will get a bad perception of the GPRS service, which of course is not acceptable for the operators.

### SUMMARY OF THE INVENTION

It is an object of the present invention to provide an arrangement that eliminates the drawbacks described above. The features defined in the claims enclosed characterize this method.

A preferred embodiment of the present invention purposes that the SGSNs stores the IMSI numbers or IMSI series having roaming restrictions in parts or whole of the respective areas covered by the SGSNs. The SGSNs may have stored this information locally in the SGSN (by configuration), or it can have access to such information from an external database, e.g. a DNS (Domain Name System) server. The roaming restrictions may e.g. be set on the whole area covered by an SGSN, per LA (Location Area), per RA (Routing Area) or even per radio cell. Therefore, the SGSN can easily check when receiving the MS data, or more specific when receiving the IMST parameter, if the MS is allowed to roam into an area. This embodiment may be utilized both in the case of an inter SGSN RAU procedure, and in the case of an inter SGSN SRNS (Serving Radio Network Subsystem) Relocation procedure.

A second embodiment of the present invention purposes that a new SGSN, in the inter SGSN RAU procedure, should receive and check the subscription data in the HLR before informing the old SGSN whether or not it was capable of handling the MS. Like in the previous embodiment, this approach uses the existing messages defined for a RAU procedure, but the order of the messages are changed slightly. This embodiment is adjusted to the inter SGSN RAU procedure

A third embodiment of the present invention purposes that a new (or target) SGSN, after having received the IMSI parameter from the old (or source) SGSN, interrogates the HLR to get the subscription data of the MS. After having received the relevant subscription data, the SGSN checks if the MS is allowed to enter this area (e.g. by checking the roaming subscription data of the MS). If the MS is allowed to enter this area, the procedure proceeds as it is defined today. If the MS is not allowed to enter this area, the new (or target) SGSN informs the old (or source) SGSN that the procedure was unsuccessful. This embodiment may be utilized both in the case of an inter SGSN RAU procedure, and in the case of an inter SGSN SRNS Relocation procedure.

The present invention enables the MS to keep its data (MM context and PDP contexts) even when an inter SGSN RAU procedure or an inter SGSN SRNS Relocation procedure is rejected due to the MS having roaming restrictions in a certain area. Unnecessary disconnections of MSs from the network in connection with roaming are then avoided. This will lead to that the subscribers get a better perception of the GPRS service, and the operators will not get complaints of a bad GPRS service.

### BRIEF DESCRIPTION OF THE DRAWINGS

In order to make the invention more readily understandable, the discussion that follows will refer to the accompanying drawings.

FIG. 1 illustrates the message float of an inter SGSN Routing Area Update Procedure according to 3GPP TS 23.060,

FIG. 2 illustrates the message float of an inter SGSN Routing Area Update Procedure in the case of roaming restriction according to a first embodiment of the present invention,

FIG. 3 illustrates the message float in an SRNS Relocation Procedure in the case of roaming restriction according to a first embodiment of the present invention,

FIG. 4 illustrates the message float of an inter SGSN is Routing Area Update Procedure in the case of roaming restriction according to a second embodiment of the present invention,

FIG. 5 illustrates the message float of an inter SGSN Routing Area Update Procedure in the case of roaming restriction according to a third embodiment of the present invention,

FIG. 6 illustrates the message float in an SRNS Relocation Procedure in the case of roaming restriction according to a third embodiment of the present invention.

### DETAILED DESCRIPTION OF PREFERRED EMBODIMENTS

The present invention is based on the idea that the new SGSN should, in inter SGSN roaming traffic cases, know the roaming restrictions of the MS before the new SGSN informs the old SGSN that it was capable of handling the MS data and the associated PDP contexts.

This present invention proposes three embodiments for how to solve this at inter SGSN roaming traffic cases.

The first embodiment of the present invention proposes that the SGSN to which an MS is roaming, from now on called the new SGSN, can get hold of which IMSI (International Mobile Subscriber Identity) numbers or IMSI series having roaming restrictions in parts of the areas, or the whole area, served by the SGSN. The SGSN may have stored this information locally in the SGSN (by configuration), or it can have access to such information from an external database, e.g. a DNS (Domain Name System) server. The roaming restrictions may e.g. be set on the whole area is covered by an SGSN, per LA (Location Area), per RA (Routing Area) or even per radio cell. Therefore, the SGSN can easily check when receiving the MS data, or more specific when receiving the IMSI parameter, if the MS is allowed to roam into an area. This embodiment may be utilized both in the case of an inter SGSN RAU procedure, and in the case of an inter SGSN SRNS (Serving Radio Network Subsystem) Relocation procedure.

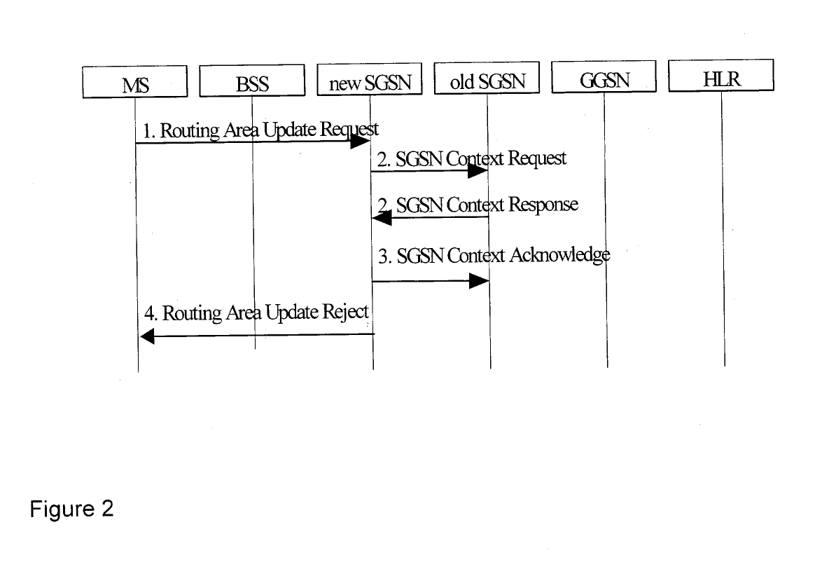

A description of the first embodiment in the case of an inter SGSN RAU procedure will now be described referring to FIG. 2.

1) The MS sends a Routing Area Update Request to the new SGSN.

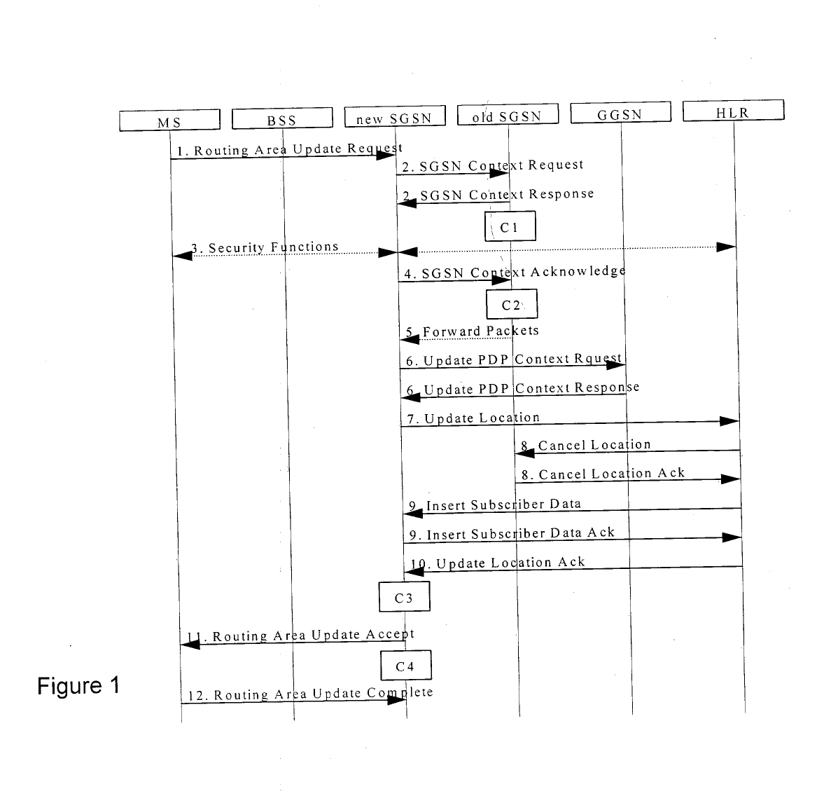

2) The new SGSN uses the old RAI (Routing Area Identity) to determine the old SGSN (in an SGSN pool network also the P-TMSI or TLLI (Temporary Logical Link Identifier) can be used to determine the old SGSN), and sends SGSN Context Request to the old SGSN to get the MM (Mobility Management) and PDP contexts for the MS. The old SGSN responds with SGSN Context Response (MM Context, PDP Contexts) and starts the ‘tunnel-timer’. In this message the new SGSN receives the IMSI parameter of the MS. Now the previously configured roaming restriction data available to the new SGSN (either locally or in an external database like e.g. a DNS server) are checked. If there are no roaming restrictions for the MS, the RAU procedure proceeds successfully as already defined in 23.060 (also shown in FIG. 1 in this document) when the new SGSN receives the SGSN Context Request message. If there is roaming restrictions for the MS, the new SGSN decides to terminate the RAU procedure, and step 3 as described below will be the next step to be performed.

3) The new SGSN sends an SGSN Context Acknowledge message to the old SGSN. This message should preferably contain a new cause value informing the old SGSN that the MS data (MM Context and PDP Contexts) must be kept. Also, the ‘tunnel-timer’ mentioned in step 2 is stopped in the old SGSN.

4) The new SGSN sends Routing Area Update Reject to the MS with a cause value indicating that the MS must keep the MM context and the PDP contexts.

In this way, the MS can search for a new radio channel belonging to another operator, and perform the RAU procedure to an SGSN of this operator. Even if the MS is not allowed to roam into the network of this operator, the subscriber will not get an abruption in the GPRS service.

According to the embodiment described above, the SGSN has access to the roaming restriction data for the different IMSI values (series), and this can e.g. be set per RA or for the whole area served by the SGSN. These data can be configured locally in the SGSN, or in an external database like a DNS server.

When receiving the SGSN Context Response message, the (new) SGSN uses the IMSI of the MS to check if the MS has roaming restrictions in the area where the MS is located. If it has roaming restrictions, the RAU procedure is aborted by that the new SGSN sends an RAU Reject towards the MS, informing the MS to keep its MM context and PDP contexts. Also, the new SGSN sends an SGSN Context Acknowledge message towards the old SGSN, informing the old SGSN to keep the MM context and PDP contexts of the MS.

Finally, a new cause code informing the old SGSN that it shall keep the MS data is introduced in the SGSN Context Acknowledge message (defined in 3GPP TS 29.060).

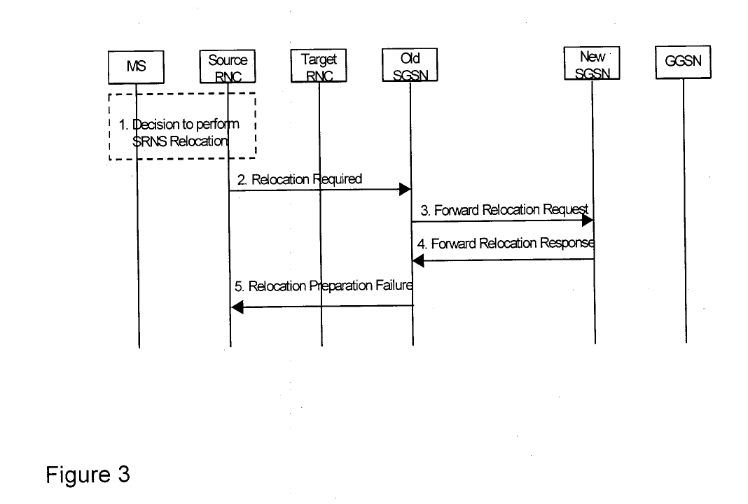

A description of the first embodiment in the case of an inter SGSN SRNS Relocation procedure will now be described referring to FIG. 3. Although only one of the SRNS Relocation procedures will be discussed, this solution is applicable to all types of SRNS Relocation.

1) The source SRNC decides to initiate an SRNS relocation.

2) The source SRNC sends a Relocation Required message to the old SGSN.

3) The old SGSN determines from the Target ID if the SRNS relocation is intra-SGSN SRNS relocation or inter-SGSN SRNS relocation. In case of inter-SGSN SRNS relocation, the old SGSN initiates the relocation resource allocation procedure by sending a Forward Relocation Request message to the new SGSN. This message contains the MM context and PDP contexts stored in the old SGSN for this MS, and therefore also the IMSI parameter of the MS. Now the previously configured roaming restriction data available to the new SGSN (either locally or in an external database like e.g. a DNS server) are checked. If there is no roaming restrictions for the MS, the SRNS Relocation procedure proceeds successfully as already defined in 23.060 when the new SGSN receives the Forward Relocation Request message. If there is roaming restrictions for the MS, the new SGSN decides to terminate the SRNS Relocation procedure, and step 4 as described below will be the next step to be performed.

4) The new SGSN sends the Forward Relocation Response message to the old SGSN with a cause code saying that the SRNS Relocation procedure was not successful. When the old SGSN receives this message with a cause code, preferably indicating that the MS had roaming restrictions in this area, the old SGSN should keep the MS data (MM Context and PDP Contexts). Any started time supervision is stopped.

5) The old SGSN sends the Relocation Preparation Failure message to the source RNC (Radio Network Controller) and indicates that the SRNS Relocation procedure was unsuccessful. Any started time supervision is stopped.

The SGSN has access to the roaming restriction data for the different IMSI values (series), and this can e.g. be set per RA or for the whole area served by the SGSN. These data can be configured locally in the SGSN, or in an external database like a DNS server.

When receiving the Forward Relocation Request message as described above, the SGSN uses the IMSI of the MS to check if the MS has roaming restrictions in the area where the MS is located. If it has roaming restrictions, the SRNS Relocation procedure is aborted by that the new SGSN sends a Forward Relocation Response message towards the old SGSN, informing the old SGSN to keep the MM context and PDP contexts of the MS, and that the procedure was unsuccessful.

The second embodiment of the present invention proposes that the new SGSN, in the inter SGSN RAU procedure, receive and check the subscription data in the HLR before informing the old SGSN whether or not it was capable of handling the MS. As in the previous embodiment, this approach uses the existing messages defined for an RAU procedure, but the order of the messages are changed slightly.

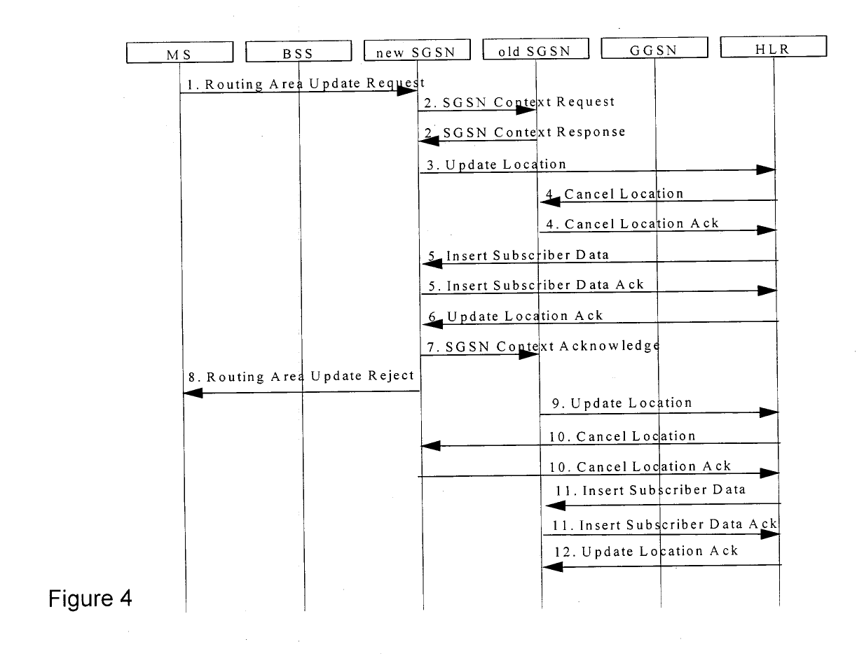

A description of this second embodiment in the case of an inter SGSN RAU procedure will now be described referring to FIG. 4. Note that this embodiment is only applicable to an inter SGSN RAU procedure due to the fact that the Insert Subscriber Data sequence does not exist in the inter SGSN SRNS Relocation procedure.

1) The MS sends a Routeing Area Update Request to the new SGSN.

2) The new SGSN sends SGSN Context Request to the old SGSN to get the MM context and PDP contexts for the MS. The old SGSN responds with SGSN Context Response (MM Context, PDP Contexts), and starts a ‘tunnel-timer’.

3) The new SGSN informs the HLR of the change of SGSN by sending Update Location to the HLR.

4) The HLR sends Cancel Location to the old SGSN. The old SGSN acknowledges with Cancel Location Ack.

5) The HLR sends Insert Subscriber Data to the new SGSN. The new SGSN validates the MS's presence in the (new) RA or area. If there is no roaming restriction for the MS and every other check on subscription data is passed successfully, the procedure proceeds successfully with all the steps already defined for the procedure in 23.060 (also shown in FIG. 1 in this document), but the order of the steps defined in 23.060 is, of course, changed slightly and no steps are performed twice. If there are roaming restrictions, or any other check on the subscription data is not passed so that the procedure must be aborted, the next step will be step 6, as described below. The SGSN shall reject the Routing Area Update Request with an appropriate cause, and preferably return an Insert Subscriber Data Ack message to the HLR.

6) The HLR acknowledges the Update Location by sending Update Location Ack to the new SGSN.

7) The new SGSN sends an SGSN Context Acknowledge message to the old SGSN. If the MS has roaming restrictions in the area where the MS is located, this message preferably includes a new cause code informing the old SGSN that it shall keep its MM context and PDP contexts. The old SGSN will then stop the ‘tunnel-timer’ started in step 2.

8) The new SGSN sends a Routing Area Update Reject to the MS, informing the MS that it shall keep its MM context and PDP contexts.

9) The old SGSN informs the HLR of the change of SGSN by sending Update Location to the HLR. This message is sent due to the received cause code in step 7.

10) The HLR sends Cancel Location to the new SGSN. The new SGSN acknowledges with Cancel Location Ack.

11) The HLR sends Insert Subscriber Data to the old SGSN. The old SGSN returns an Insert Subscriber Data Ack message to the HLR.

12) The HLR acknowledges the Update Location by sending Update Location Ack to the old SGSN.

Note that the Security functions may be executed any time after step 2 in this new sequence although it is not shown in this figure.

There might also be variations in which sequence the steps are performed, without changing the concept of the patent.

Also, how to perform the successful RAU procedure is not shown here, i.e. after the re-scheduling of the steps. However, the important issue with the latter embodiment is that the new SGSN contacts the HLR before sending the SGSN Context Acknowledge to the old SGSN. In this way, the new SGSN will have available the data required to determine if the MS is allowed to roam into the current area before the new SGSN informs the old SGSN whether the inter SGSN RAU procedure was successful or not.

Still referring to the second embodiment, when receiving the SGSN Context Response message, the new SGSN (preferably immediately) contacts the HLR with the Update Location message to receive information on the MS and checks if the MS has roaming restrictions in the area where the MS is located. If the MS has roaming restrictions, the inter SGSN RAU procedure is aborted by that the new SGSN sends a RAU Reject towards the MS, informing the MS to keep its MM context and PDP contexts. Also, the new SGSN sends an SGSN Context Acknowledge message towards the old SGSN, informing the old SGSN to keep the MM context and PDP contexts of the MS.

As in the first embodiment, a new cause code informing the old SGSN that it shall keep the MS data is preferably introduced in the SGSN Context Acknowledge message (defined in 3GPP TS 29.060).

Optionally, the SGSN Context Acknowledge message can also be updated to include TEIDs (Tunnel End Point Identities) and IP (Internet Protocol) addresses of the involved GGSN(s), so that the old SGSN can again update the GTP tunnels towards the involved GGSN(s). This should be done if the new SGSN updates the GTP tunnels towards the involved GGSN(s) before noticing that the MS has roaming restrictions in the area where it is located. The new SGSN can also, in this message, indicate to the old SGSN which GTP tunnels that were updated (towards GGSNs), and which tunnels that were not updated. In this way, the old SGSN knows which GTP tunnels it has to update.

The old SGSN should upon reception of this SGSN Context Acknowledge, preferably containing a new cause code, send an Update Location towards the HLR, so that the HLR again is informed which SGSN keeps the MS data. The Update Location message will trigger the normal behaviour in the HLR (send Cancel Location and Insert Subscriber Data).

The third embodiment of the present invention purposes that the new SGSN, after having received the IMSI parameter from the old SGSN, interrogates the HLR to get some or all the subscription data of the MS. After having received the relevant subscription data, the new SGSN checks if the MS is allowed to enter this area (e.g. by checking the roaming subscription data of the MS). If the MS is allowed to enter this area, the procedure proceeds as it is defined today. If the MS is not allowed to enter this area, the new SGSN informs the old SGSN that the procedure was unsuccessful.

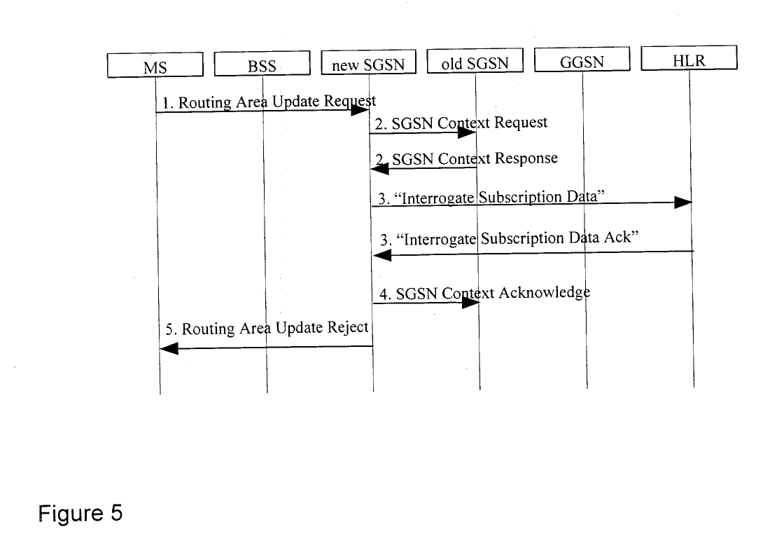

A description of the third embodiment in the case of an inter SGSN RAU procedure will now be described referring to FIG. 5.

1) The MS sends a Routeing Area Update Request to the new SGSN.

2) The new SGSN sends SGSN Context Request to the old SGSN to get the MM context and PDP contexts for the MS. The old SGSN responds with SGSN Context Response (MM Context, PDP Contexts), and starts a ‘tunnel-timer’.

3) The new SGSN interrogates the HLR to receive some or all subscription data of the MS. It might be required to send one or more messages towards the HLR before getting the required information of the MS, and the HLR might send one or more messages to the new SGSN before the required information of the MS is sent to the new SGSN, but here it is simplified to being called “Interrogate Subscription Data/Ack”. If there is no roaming restriction for the MS in this area and every other check on subscription data is passed successfully, the procedure proceeds successfully as defined in 23.060 (also shown in FIG. 1 in this document, i.e. a successful SGSN Context Acknowledge is returned to the old SGSN, etc). If there is roaming restrictions, or any other check on the subscription data is not passed so that the procedure must be aborted, the next step will be step 4 as described below.

4) The new SGSN sends an SGSN Context Acknowledge message to the old SGSN. This message preferably includes a new cause code informing the old SGSN that it shall keep its MM context and PDP contexts. The old SGSN will then stop the ‘tunnel-timer’ started in step 2.

5) The new SGSN sends a Routing Area Update Reject to the MS, informing the MS that it shall keep its MM context and PDP contexts.

Consequently, when receiving the SGSN Context Response message, the new SGSN (preferably immediately) contacts the HLR to receive information on the MS and checks if the MS has roaming restrictions in the area where the MS is located (or if there is any other restrictions for the MS). If the MS has any restrictions, the inter SGSN RAU procedure is aborted by that the new SGSN sends an RAU Reject towards the MS, informing the MS to keep its MM context and PDP contexts. Also, the new SGSN sends an SGSN Context Acknowledge message towards the old SGSN, informing the old SGSN to keep the MM context and PDP contexts of the MS.

Similar to the first and the second embodiment, a new cause code informing the old SGSN that it shall keep the MS data is preferably introduced in the SGSN Context Acknowledge message (defined in 3GPP TS 29.060).

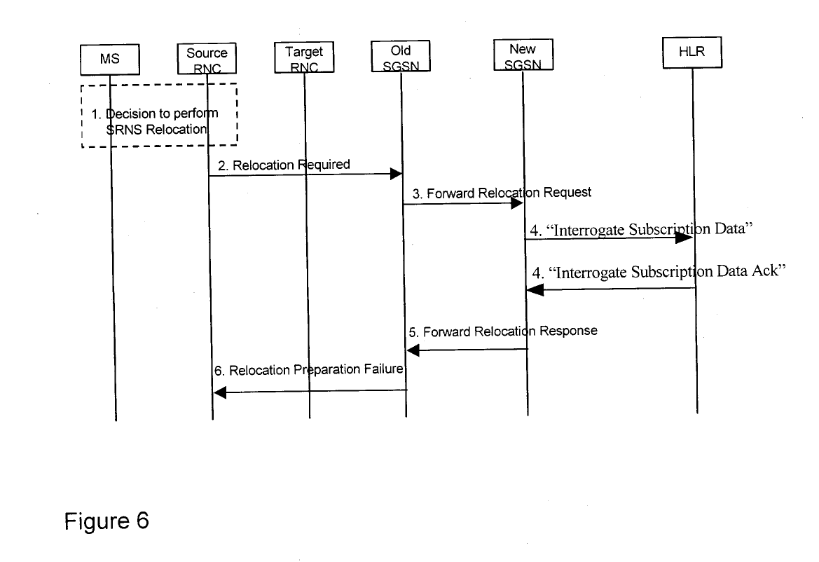

A description of the third embodiment in the case of an inter SGSN SRNS Relocation procedure will now be described referring to FIG. 6. Although only one of the SRNS Relocation procedures will be discussed, this solution is applicable to all types of SRNS Relocation.

1) The source SRNC decides to initiate an SRNS relocation.

2) The source SRNC sends a Relocation Required message to the old SGSN.

3) The old SGSN determines from the Target ID if the SRNS relocation is intra-SGSN SRNS relocation or inter-SGSN SRNS relocation. In case of inter-SGSN SRNS relocation the old SGSN initiates the relocation resource allocation procedure by sending a Forward Relocation Request message to the new SGSN. This message contains the MM context and PDP contexts stored in the old SGSN for this MS, and therefore also the IMSI parameter of the MS.

4) The new SGSN interrogates the HLR to receive some subscription data of the MS. It might be required to send one or more messages towards the HLR before getting the required information of the MS, and the HLR might send one or more messages to the new SGSN before the required information of the MS is sent to the new SGSN, but here it is simplified to being called “Interrogate Subscription Data/Ack”. If there is no roaming restriction for the MS in this area and every other check on subscription data is passed successfully, the procedure proceeds successfully as defined in 23.060 after having received the Forward Relocation Request message in the new SGSN. If there are roaming restrictions, or any other check on the subscription data is not passed so that the procedure must be aborted, the next step will be step 5 as described below.

5) The new SGSN sends the Forward Relocation Response is message to the old SGSN with a cause code saying that the SRNS Relocation procedure was unsuccessful. When the old SGSN receives this message with a cause code, preferably indicating that the MS had roaming restrictions in this area, the old SGSN should keep the MS data (MM Context and PDP Contexts). Any started time supervision is stopped.

6) The old SGSN sends the Relocation Preparation Failure message to the source RNC (Radio Network Controller) and indicates that the SRNS Relocation procedure was unsuccessful. Any started time supervision is stopped.

In other words, upon receipt of the Forward Relocation Request message, the new SGSN (preferably immediately) contacts the HLR to receive information on the MS and checks if the MS has roaming restrictions in the area where the MS is located (or if there is any other restrictions for the MS). If the MS has any restrictions, the SRNS Relocation procedure is aborted by that the new SGSN sends a Forward Relocation Response message towards the old SGSN, informing the old SGSN to keep the MM context and PDP contexts of the MS, and that the procedure was unsuccessful.

The first embodiment of the present invention is the simplest embodiment to implement. No new signalling is required; in fact, the signalling will not have to be changed at all.

The second and third embodiments require a change and an introduction of new signalling, respectively. On the other hand, these embodiments cover all types of roaming restrictions which are based on subscription data.

The present invention enables the MS to keep its data (MM context and PDP contexts) even when an inter SGSN RAU procedure or an inter SGSN SRNS Relocation procedure is rejected due to the MS having roaming restrictions in a certain area. This will lead to that the subscribers get a better perception of the GPRS service, and the operators will not receive complaints of a bad GPRS service. Consequently, the present invention provides solutions being acceptable for subscribers and operators, and will therefore reduce the cost of deploying GPRS networks for the operators.

The present invention is applicable for both GSM GPRS and UMTS GPRS.

However, even an MSC/VLR (Mobile Services Switching Centre/Visitor Location Register) located in a UMTS network might have advantages of configuring and storing which IMSI values or IMSI series have roaming restrictions (instead of receiving this data from the HLR). If this is done, the same solution can be applied for the SRNS Relocation procedure applicable for UMTS circuit switched scenarios, since this procedure is defined in the circuit switched domain as well.

### References

3GPP: 3GPP TS (Technical Specification) 23.060

3GPP: 3GPP TS (Technical Specification) 29.060

1. A method in a GPRS environment executing a possible roaming restriction for a subscriber when a terminal associated with that subscriber initiates a roaming procedure intended to transfer handling of the terminal from a first serving node to a second serving node, characterized in
a) when the second serving node receives a unique identity code of the subscription associated with the subscriber in a message of the initiated roaming procedure, determining if it is allowed to fulfil the roaming procedure by inquiring whether the unique identity code is among identity codes or identity code series stored in the second serving node or in a data base connected thereto, as said stored identity codes or identity code series indicate which subscriptions being allowed to roam into the second serving node,
b) if it is determined that the roaming procedure is not allowed to be fulfilled, interrupting the roaming procedure and informing the first serving node to keep handling the terminal and informing the terminal that the initiated roaming procedure was rejected.

2. Method according to claim 1, characterized in that the serving nodes are SGSN's in different or within the same GPRS UMTS and/or GPRS GSM network(s).

3. Method according to claim 2, characterized in that the identity codes are IMSI numbers, the identity code series are IMSI series and the unique identity code is the IMSI number of the subscription.

4. Method according to one of claims 2 or 3, characterized in that the roaming procedure is an inter SGSN Routing Area Update procedure, and said message is an SGSN Context Response.

5. Method according to claim 4, characterized in that informing the first SGSN to keep handling the terminal in step b) is executed by transmitting an SGSN Context Acknowledge message to the first SGSN, preferably including a new cause code, indicating to the first SGSN to keep all existing data regarding the terminal, e.g. MM Contexts and PDP Contexts.

6. Method according to one of the claims 2 or 3, characterized in that the roaming procedure is an inter SGSN SRNS Relocation Procedure, and said message is a Forward Relocation Request.

7. Method according to claim 6, characterized in that the informing of the first SGSN to keep handling the terminal in step b) is executed by transmitting an Forward Relocation Response message to the first SGSN, preferably including a new cause code, indicating to the first SGSN to keep all existing data regarding the terminal, e.g. MM Contexts and PDP Contexts.

8. Method in a GPRS environment executing a possible roaming restriction for a subscriber when a terminal associated with that subscriber initiates an inter SGSN Routing Area Update procedure intended to transfer handling of the terminal from a first SGSN to a second SGSN, roaming restrictions of the subscription associated with the subscriber are defined in an HLR of which, and these restrictions are contained in the Insert Subscriber Data message of said procedure, characterized in
a) transmitting a first Update Location message of the inter SGSN Routing Area Update procedure from the second SGSN to the HLR upon reception of the SGSN Context Response of said procedure so that the second SGSN receives the Insert Subscriber Data message previous to transmission of the SGSN Context Acknowledge message of the procedure,
b) determining if it is allowed to fulfil the procedure by examining the roaming restrictions of the subscription contained in the Insert Subscriber Data message,
c) if it is determined that the procedure is not allowed to be fulfilled, interrupting the procedure and informing the first SGSN to keep handling the terminal by including a certain cause code in the SGSN Context Acknowledge that is transmitted to the first SGSN, and informing the terminal that the initiated roaming procedure was rejected by transmitting a Routing Area Update Reject to the terminal.

9. Method according to claim 8, characterized in that the first and second SGSN is localized in different or within the same GPRS UMTS and/or GPRS GSM network(s).

10. Method according to claim 8 or 9, characterized in that the SGSN Context Acknowledge includes Tunnel End Point Identities and Internet Protocol addresses of possible GGSNs for PDP contexts activated for the terminal, if the second SGSN already has updated one or more communication tunnels towards the GGSNs.

11. Method according to claim 10, characterized in that the SGSN Context Acknowledge includes information indicating which of the tunnel(s) that the second SGSN has updated.

12. Method according to one of the claims 8-11, characterized in
d) transmitting a second Update Location message of the inter SGSN Routing Area Update procedure from the first SGSN to the HLR upon reception of the SGSN Context Acknowledge, informing the HLR which of the SGSNs is now handling the terminal.

13. Method according to one of the claims 9, characterized in that the roaming restrictions indicate into which SGSNs, or which areas served by an SGSN the terminal is not allowed to roam.

14. A method in a GPRS environment executing a possible roaming restriction for a subscriber when a terminal associated with that subscriber initiates a roaming procedure intended to transfer handling of the terminal from a first serving node to a second serving node, roaming restrictions of the subscription associated with the subscriber are defined in an HLR of the subscription, characterized in
a) when the second serving node receives a unique identity code of the subscription associated with the subscriber in a message of the initiated roaming procedure, requesting the HLR for at least the roaming restrictions of the subscription,
b) upon receiving the roaming restrictions of the subscription from the HLR, examining the roaming restrictions to determine if it is allowed to fulfil the procedure,
c) if it is determined that the roaming procedure is not allowed to be fulfilled, interrupting the roaming procedure and informing the first serving node to keep handling the terminal and informing the terminal that the initiated roaming procedure was rejected.

15. Method according to claim 14, characterized in that the serving nodes are SGSN's in different or within the same GPRS UMTS and/or GPRS GSM network(s).

16. Method according to claim 15, characterized in that the roaming restrictions indicate into which SGSNs or which areas served by an SGSN the terminal is not allowed to roam.

17. Method according to claim 15 or 16, characterized in that the unique identity code is the IMSI number of the subscription.

18. Method according to one of the claims 15, 16 or 17, characterized in that the roaming procedure is an inter SGSN Routing Area Update procedure, and said message is an SGSN Context Response.

19. Method according to claim 18, characterized in that the informing of the first SGSN to keep handling the terminal in step b) is executed by transmitting an SGSN Context Acknowledge message to the first SGSN, preferably including a new cause code, indicating to the first SGSN to keep all existing data regarding the terminal, e.g. MM Contexts and PDP Contexts.

20. Method according to one of the claims 15, 16 or 17, characterized in that the roaming procedure is an inter SGSN SRNS Relocation Procedure, and said message is a Forward Relocation Request.

21. Method according to claim 20, characterized in that informing the first SGSN to keep handling the terminal in step b) is executed by transmitting a Forward Relocation Response message to the first SGSN, preferably including a new cause code, indicating to the first SGSN to keep all existing data regarding the terminal, e.g. MM Contexts and PDP Contexts.
